(19) United States
(12) Patent Application Publication
(10) Pub. No.: US 2012/0117002 A1
(43) Pub. Date: May 10, 2012

(54) MARKET-TARGETED PATENT APPLICATION OF ENHANCED COMMERCIAL EFFECTIVENESS AND VALUE AND METHODS FOR PREPARING THE PATENT APPLICATION USING INVENTION MARKET ANALYSIS

(76) Inventors: Russ Weinzimmer, Milford, NH (US); Joseph Jacob Carlen, San Diego, CA (US); Joseph Aufiero, Center Ossipee, NH (US)

(21) Appl. No.: 12/942,018

(22) Filed: Nov. 8, 2010

(51) Int. Cl. G06Q 90/00

(52) U.S. Cl. 705/500

(57) ABSTRACT

A market-targeted patent application of enhanced commercial effectiveness and value, as well as methods for preparing the market-targeted patent application using invention market analysis, is disclosed. In preparing a patent application, invention market analysis of a proposed invention is used, in addition to the invention disclosure of the proposed invention, so as to target the patent application towards the invention's primary and most promising markets. Invention market analysis can affect patent strategy, invention description, patent claims, and/or other key aspects of a patent application, also potentially reshaping the invention's scope in the process. In some embodiments, the proposed invention is clarified by prior art analysis, and/or defined by standard claims. In key embodiments, market-targeted claims are drafted in light of invention market analysis, thereby serving as the foundation for a market-targeted patent application. If the invention is modified in light of invention market analysis, additional disclosure is obtained as needed.

### FIELD

This invention relates generally to patents, and more particularly to patent applications and methods for preparing patent applications.

### BACKGROUND

A patent provides its owner with exclusive rights over an invention claimed therein for the life of the patent's enforceable term. By effectively asserting these rights, a patent owner can protect business interests in the patented invention well after it has entered the marketplace.

Given the background and training of most patent applicants and patent professionals, preparation of patent applications is typically guided primarily by technical and legal considerations. Further, it is common wisdom among patent professionals that an invention should be claimed and described as broadly as possible in a patent application.

However, regarding patent prosecution, a patent application that is drafted as broadly as possible can often lead to protracted and costly prosecution within the US Patent & Trademark Office and its foreign counterparts, without commensurate commercial benefit accruing to the patent applicant.

Moreover, examining such a maximally broad patent application requires extra time and attention from patent examiners as well, thereby creating inefficiencies that burden the patent system with little benefit to the public.

Regarding patent assertion, if such a maximally broad patent application does not contain sufficiently broad enabling technical disclosure, a patent issuing from the patent application is more likely to be construed narrowly, and therefore more likely to face non-infringement issues when asserted broadly.

The difficulties faced in the assertion of such maximally broad patents can also burden the judicial system by filling court dockets with excessive amounts of protracted patent litigation.

### SUMMARY

According to the present invention, patent professionals have not given enough attention to maximizing an important benefit of patents: commercial effectiveness. Although patent holders hope that a patent will help them to capitalize on their invention in the marketplace, current patent preparation practice fails to sufficiently consider this important goal. As further recognized by the present invention, it is unrealistic to expect professionals with mostly technical and legal expertise to naturally have sufficient understanding of actual or potential markets for an invention. Therefore, such professionals are presently not best equipped to prepare commercially effective patent applications.

For example, many technical experts believe that only complex or clever inventions should be patented, with little regard for their commercial value. On the other hand, many legal experts adopt an abstract perspective when defining and describing an invention, without sufficient consideration of commercial realities. As recognized by the present invention, careful analysis of the markets of a given invention can substantially aid in determining the most commercially useful scope and direction of a patent application on the invention.

A market-targeted patent application of enhanced commercial effectiveness and value is disclosed and claimed, as well as methods for preparing such patent applications using analysis of important markets of an invention (such analysis hereinafter referred to as “invention market analysis”). As recognized by the present invention, this approach uses invention market analysis not merely to decide whether or not to pursue a patent, but also to determine how best to go about preparing a patent application.

Rather than attempting to achieve maximum claim breadth without investigating an invention's commercial possibilities, a patent application prepared in view of invention market analysis will be intentionally targeted towards the invention's most promising markets and commercial applications. By targeting the invention towards its most promising markets rather than pursuing maximum claim breadth, the patent application can be prosecuted more efficiently, and can be more commercially effective during its enforceable term as an issued patent.

Patent applications prepared using invention market analysis take advantage of a mutually reinforcing, synergistic effect between considering technical and legal issues, as well as considering commercial possibilities, at the same time. In considering an invention's commercial possibilities, new technical and legal possibilities may be revealed. Conversely, when considering an invention's technical and legal possibilities, new commercial possibilities may be revealed. Therefore, in preparing a patent application while integrating all three of these considerations (technical, legal, and commercial), an invention can be commercialized more efficiently than if only one or two of these considerations are addressed at a time.

Preparing a patent application using invention market analysis can change the scope of an invention, thereby enhancing the strategic and commercial value of the patent that issues therefrom. For example, invention market analysis of an invention may reveal surprisingly lucrative or previously unanticipated markets for that invention, thereby encouraging a reshaping the scope of the invention, such as narrowing or broadening the scope of the invention, and/or shifting the scope of the invention, such as redirecting the scope of the invention into a new market or new markets. In some cases, the shift can be so extensive as to fully displace the scope of the invention into a completely new market, perhaps even changing the subject matter of the invention substantially. In other cases, the invention market analysis can lead to a subdividing of the invention, such as a bifurcating or even trifurcating of what appeared to be a single invention into a plurality of more commercially targeted inventions.

In some cases, such invention market analysis may reveal that certain previously anticipated markets are actually weaker than expected or essentially nonexistent, thereby encouraging further refinement of the scope of the invention. In other cases, invention market analysis may reveal new markets that had not been previously anticipated, thereby encouraging further refinement, broadening, or some other change of the inventive scope.

As recognized by the invention, patent applications that claim as much as possible solely in view of the prior art can provoke avoidable arguments from the US Patent & Trademark Office, thereby extending the period of patent prosecution, and consequently raising the costs of obtaining an issued patent. Furthermore, upon issuance, an unnecessarily broad patent can lead to commercially unproductive litigation.

Using invention market analysis in preparing a patent application can help ensure that a proposed invention is construed as broadly as possible in its strongest projected markets, but not claimed in areas where the invention's market potential is shown to be weak or nonexistent. Such a strategy gives patent applicants confidence that they are effectively pursuing commercially relevant protection on their invention, while at the same time avoiding unnecessary and costly claim breadth.

Patent applications that have been prepared using invention market analysis are less likely to be arbitrarily broad, and/or less likely to inappropriately claim commercially irrelevant embodiments. Such patent applications can therefore encounter less opposition from the US Patent & Trademark Office, thereby lowering the risk of wasting patent prosecution time, money, and other resources.

As a result, patent applications prepared using invention market analysis can also help Patent Examiners by enabling them to more rapidly and efficiently advance the prosecution of patent applications so written. The US Patent & Trademark Office is currently backlogged with many patent applications, which leads to various inefficiencies in an Examiner's work schedule. Examiner tasks such as prior art searching and arguing against invention patentability can be streamlined for these “market-targeted patent applications,” thereby creating higher levels of efficiency within domestic and foreign government patent offices.

A patent application prepared using invention market analysis also minimizes the possibility of facing non-infringement issues when the patent application is later asserted as an issued patent. A patent application prepared using invention market analysis is targeted towards certain commercially viable embodiments of an invention.

Therefore, the claimed invention is more likely to be supported by sufficiently broad enabling technical disclosure, and as a result, the apparent metes and bounds of the claimed invention will be more commensurate with the enforceable claims scope. Consequently, the enforceable claim scope of these market-targeted patent applications will be easier to identify, thereby relieving the court system of excessive amounts of patent infringement litigation.

One general aspect of the invention is a method for preparing a market-targeted patent application of enhanced commercial effectiveness and value. The method includes obtaining an invention disclosure of a proposed invention; obtaining an invention market analysis of the proposed invention, the invention market analysis being performed using the invention disclosure of the proposed invention; and preparing a patent application using: the invention disclosure of the proposed invention; and the invention market analysis of the proposed invention.

In a preferred embodiment, before the invention market analysis is performed, the proposed invention is clarified by at least one of: analyzing known prior art so as to ascertain a potentially patentable scope of the proposed invention in light of the known prior art; and drafting a set of standard patent claims so as to define a potentially patentable scope of the proposed invention in light of the invention disclosure.

In another preferred embodiment, results of the invention market analysis of the proposed invention are provided in a market report, the market report including at least one of: an objective professional study; and an informed subjective professional opinion.

In another preferred embodiment, the method further includes: before preparing the patent application, and if the proposed invention has been modified before or during invention market analysis, thereby providing a modified invention, and if the modified invention needs additional disclosure to support claims to the modified invention, obtaining additional disclosure needed to support the claims to the modified invention.

In a preferred embodiment, the method further includes: before preparing the patent application, and if the proposed invention has been modified before or during invention market analysis, thereby providing a modified invention, and if the modified invention requires analysis of known prior art so as to ascertain a potentially patentable scope of the modified invention, analyzing known prior art so as to ascertain a potentially patentable scope of the modified invention in light of the known prior art.

In a preferred embodiment, at least one of: the invention market analysis; and preparing the patent application so as to provide a market-targeted patent application, is performed by at least one of: an inventor of the proposed invention; a market professional; and a patent professional.

In a preferred embodiment, preparing the patent application includes at least one of: creating a patent strategy in light of the invention market analysis of the proposed invention, so as to provide a market-targeted patent strategy; describing the proposed invention in light of the invention market analysis of the proposed invention, so as to provide a market-targeted invention description; and drafting patent claims in light of the invention market analysis of the proposed invention, so as to provide market-targeted patent claims.

In a preferred embodiment, preparing the patent application includes using the invention market analysis of the proposed invention to perform at least one of: reshaping the scope of the proposed invention; narrowing the scope of the proposed invention; broadening the scope of the proposed invention; shifting the scope of the proposed invention; redirecting the scope of the proposed invention; displacing the scope of the proposed invention; subdividing the proposed invention; bifurcating the proposed invention; and trifurcating the proposed invention.

Another general aspect of the invention is a market-targeted patent application of enhanced commercial effectiveness and value, the application produced by the method including: obtaining an invention disclosure of a proposed invention; obtaining an invention market analysis of the proposed invention, the invention market analysis being performed using the invention disclosure of the proposed invention; and preparing a patent application using: the invention disclosure of the proposed invention; and the invention market analysis of the proposed invention.

In a preferred embodiment, before the invention market analysis is performed, the proposed invention is clarified by at least one of: analyzing known prior art so as to ascertain a potentially patentable scope of the proposed invention in light of the known prior art; and drafting a set of standard patent claims so as to define a potentially patentable scope of the proposed invention in light of the invention disclosure.

In a preferred embodiment, results of the invention market analysis of the proposed invention are provided in a market report, the market report including at least one of: an objective professional study; and an informed subjective professional opinion.

In a preferred embodiment, the method further includes: before preparing the patent application, and if the proposed invention has been modified before or during invention market analysis, thereby providing a modified invention, and if the modified invention needs additional disclosure to support claims to the modified invention, obtaining additional disclosure needed to support the claims to the modified invention.

In a preferred embodiment, the method further includes: before preparing the patent application, and if the proposed invention has been modified before or during invention market analysis, thereby providing a modified invention, and if the modified invention needs analysis of known prior art so as to ascertain a potentially patentable scope of the modified invention, analyzing known prior art, so as to ascertain a potentially patentable scope of the modified invention in light of the known prior art.

In a preferred embodiment, at least one of: the invention market analysis; and preparing the patent application, is performed by at least one of: an inventor of the proposed invention; a market professional; and a patent professional.

In a preferred embodiment, preparing the patent application includes at least one of: creating a patent strategy in light of the invention market analysis of the proposed invention, so as to provide a market-targeted patent strategy; describing the proposed invention in light of the invention market analysis of the proposed invention, so as to provide a market-targeted invention description; and drafting patent claims in light of the invention market analysis of the proposed invention, so as to provide market-targeted patent claims.

In a preferred embodiment, preparing the patent application includes using the invention market analysis of the proposed invention to perform at least one of: reshaping the scope of the proposed invention; narrowing the scope of the proposed invention; broadening the scope of the proposed invention; shifting the scope of the proposed invention; redirecting the scope of the proposed invention; displacing the scope of the proposed invention; subdividing the proposed invention; bifurcating the proposed invention; and trifurcating the proposed invention.

Another general aspect of the invention is a method for preparing a market-targeted patent application of enhanced commercial effectiveness and value, where the method includes: obtaining a set of standard claims based on a proposed invention, the set of standard claims being drafted so as to define a potentially patentable scope of the proposed invention in light of the invention disclosure; obtaining an invention market analysis of the proposed invention, the invention market analysis being performed using the set of standard claims based on the proposed invention; drafting patent claims in light of the invention market analysis of the proposed invention, so as to provide market-targeted patent claims; and preparing a patent application using the market-targeted patent claims.

In a preferred embodiment, before the invention market analysis is performed, the proposed invention is clarified by: analyzing known prior art so as to ascertain a potentially patentable scope of the proposed invention in light of the known prior art.

In a preferred embodiment, results of the invention market analysis of the proposed invention are provided in a market report, the market report including at least one of: an objective professional study; and an informed subjective professional opinion.

In a preferred embodiment, the method further includes: before preparing the patent application so as to provide a market-targeted patent application, and if the proposed invention has been modified before or during invention market analysis, thereby providing a modified invention, and if the modified invention needs additional disclosure to support claims to the modified invention, obtaining additional disclosure needed to support the claims to the modified invention.

In a preferred embodiment, the method further includes: before preparing the patent application, and if the proposed invention has been modified before or during invention market analysis, thereby providing a modified invention, and if the modified invention needs analysis of known prior art so as to ascertain a potentially patentable scope of the modified invention, analyzing known prior art so as to ascertain a potentially patentable scope of the modified invention in light of the known prior art.

In a preferred embodiment, at least one of: the invention market analysis; drafting patent claims in light of the invention market analysis of the proposed invention, so as to provide market-targeted patent claims; and preparing the patent application, is performed by at least one of: an inventor of the proposed invention; a market professional; and a patent professional.

In a preferred embodiment, preparing the patent application includes at least one of: creating a patent strategy in light of the invention market analysis of the proposed invention, so as to provide a market-targeted patent strategy; describing the proposed invention in light of the invention market analysis of the proposed invention, so as to provide a market-targeted invention description; and including claims from the set of standard claims, along with claims from the market-targeted claims, within the market-targeted patent application.

In a preferred embodiment, preparing the patent application includes using the invention market analysis of the proposed invention to perform at least one of: reshaping the scope of the proposed invention; narrowing the scope of the proposed invention; broadening the scope of the proposed invention; shifting the scope of the proposed invention; redirecting the scope of the proposed invention; displacing the scope of the proposed invention; subdividing the proposed invention; bifurcating the proposed invention; and trifurcating the proposed invention.

Another general aspect of the invention is a market-targeted patent application of enhanced commercial effectiveness and value, where the application is produced by the method including: obtaining a set of standard claims based on a proposed invention, the set of standard claims being drafted so as to claim a potentially patentable scope of the proposed invention in light of the invention disclosure; obtaining an invention market analysis of the proposed invention, the invention market analysis being performed using the set of standard claims based on the proposed invention; drafting patent claims in light of the invention market analysis of the proposed invention, so as to provide market-targeted patent claims; and preparing a patent application using the market-targeted patent claims.

### BRIEF DESCRIPTION OF THE DRAWINGS

The invention will be more fully understood by reference to the detailed description, in conjunction with the following figures, wherein:

FIG. 1 is a representation of an inventive concept within an initially contemplated field of potentially patentable subject matter, itself contained within a plane of all possible subject matter, the plane being combined with an orthogonal commercial value dimension so as to create a commercial value space;

FIG. 2 is an illustration of a commercial value terrain existing within the commercial value space of FIG. 1, and extending beyond the initially contemplated field of potentially patentable subject matter of FIG. 1, various features of the commercial value terrain representing the commercial value of various aspects of an invention;

FIG. 3 is a flow diagram showing the general steps of preparing a patent application in accordance with an embodiment of the current invention;

FIG. 4 is a flow diagram showing the general steps of preparing a patent application in accordance with an embodiment of the current invention, including obtaining additional disclosure needed to support modifications made to the invention in light of invention market analysis;

FIG. 5 is a flow diagram showing the steps of an embodiment of the invention, wherein the invention undergoes prior art analysis before undergoing invention market analysis;

FIG. 6 is a flow diagram showing the steps of an embodiment of the invention, wherein the process for creating a market-targeted patent application involves both standard claims and market-targeted claims;

FIG. 7 is a flow diagram showing the steps of an embodiment of the invention, wherein the invention undergoes prior art analysis before undergoing invention market analysis, and wherein the process for creating a market-targeted patent application involves both standard claims and market-targeted claims;

FIG. 8 is a cyclical flow diagram showing the steps of an embodiment of the invention, wherein preparation of the patent application includes providing an invention market analysis, a market-targeted description, and prior art analysis;

FIG. 9 is a set diagram showing the overlapping expertise offered by a patent professional, an inventor, and a market professional, in preparing a patent application informed by invention market analysis of a proposed invention; and

FIG. 10 is an illustration of the various ways that scope of an invention can be changed in light of invention market analysis.

### DETAILED DESCRIPTION

For the purposes of this application, certain words and phrases are to be interpreted broadly. Specifically, the word “inventor” can refer to an inventor as defined by applicable patent law and patent rules, as well as to any party that might stand in the shoes of the inventor, such as an assignee of a patent application of the inventor.

The term “patent professional” can refer to any professional who is licensed to practice the patent profession, such as a patent attorney or a patent agent.

The term “market professional” can refer to any professional with a background and/or training in marketing, finance, and/or macroeconomics, including a graduate of an MBA program, or the like.

An “invention market analysis” of a proposed invention is a comprehensive study of current and potential market(s) for that proposed invention. As a comprehensive study, the invention market analysis provides detailed information on the current and potential market(s) for the proposed invention, such as quantification of the size, strength, and/or future prospects of those markets.

Invention market analysis findings can also be put into an invention market report. Such an invention market report can present the findings of invention market analysis for a particular invention, and can include an objective professional study, and/or an informed subjective professional opinion, for example.

An invention market report can distill the findings from an invention market analysis in an understandable and/or effective manner. For example, in some embodiments the invention market report can present the findings of the invention market analysis in a manner conducive to invention reformulation and/or preparation of a market-targeted patent application.

An invention market analysis can also look beyond the horizons of markets (and segments thereof) contemplated by the inventor, so as to consider the full range of market opportunities for the invention. Subsequently, the invention market analysis can quantify each of the various market opportunities for the invention, and identify the most attractive market opportunities for the invention within the considered range. Based upon this research and analysis, an invention can be defined in a new way, so as to be most attractive to the markets deemed to have the greatest potential for the invention.

To maximize the commercial viability of an invention, such far-reaching and insightful invention market analysis might reveal new incarnations of the invention, with new applications and/or functions thereof. Invention market analysis can also even suggest new or different inventive elements to be added to the invention. Therefore, a careful and thorough invention market analysis can often lead to a change in the scope or subject matter of the invention. For this reason, the very process of considering an invention's market value can potentially impact the inventive process itself.

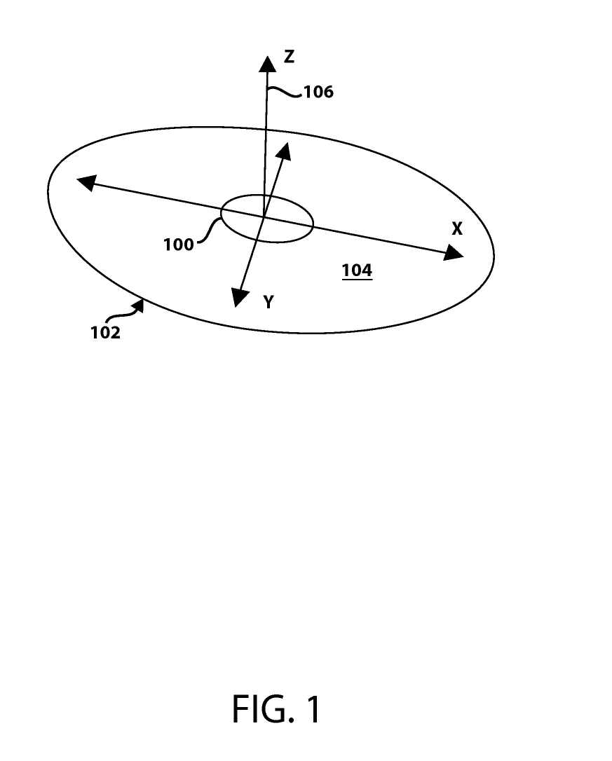

With reference to FIG. 1, a typical inventive spark of insight, or “eureka” moment, relates to a single inventive concept 100, whereas the traditional process of preparing a patent application on that inventive concept relates to a larger field of an initially contemplated field of potentially patentable subject matter 102 surrounding and enveloping the inventive concept. This field 102 is limited by considerations of 35 U.S.C. §101, §102, and possibly §103, i.e., what is patentable subject matter, as well as what is novel and not explicitly suggested or motivated in light of known prior art. But otherwise, this field 102 can be expanded by means of logic and creativity, up to the limits imposed by the prior art.

FIG. 1 is a representation of an inventive concept 100 within an initially contemplated field of potentially patentable subject matter 102 within the XY-plane 104, combined with a commercial value dimension 106 so as to create a commercial value space. An inventive concept 100 is shown as a small circle representing the beginning stages of an inventive insight. The initially contemplated field of potentially patentable subject matter 102 is the field of inventive subject matter deemed patentable by an individual upon careful review of the inventive concept 100 and the prior art.

The initially contemplated field of potentially patentable subject matter 102 lies in the XY-plane 104, which is the dimension in which the inventive concept 100 can be expanded. The Z-axis 106 represents the dimension of commercial value of each aspect of an invention. The Z-axis 106 combines with the XY-plane 104 so as to create a commercial value space 108. The inventive concept 100 can be expanded by a patent professional using logic and creativity, up to but not including what is found in the prior art, so as to provide the initially contemplated field of inventive subject matter 102.

As opposed to the aforementioned approach to defining the invention, another approach to defining the invention is for the patent professional to not expand the inventive concept 100 at all, but to simply prepare a patent application according to no more than an inventor's original vision of the invention.

In contrast to both of these extremes, the present method for preparing a patent application provides a third way. The present method for preparing a patent application provides a strategy for shaping the inventive concept 100 in the most commercially effective manner, by claiming an inventive scope that will yield the greatest commercial value, while also respecting the limits of the prior art.

Some patent professionals trust the inventor's statements regarding the scope of the invention, and they do not attempt to expand upon the inventor's inventive concept 100 to a significant degree. However, the inventor's perspective may be limited by an exclusive focus on technical concerns, for example. Therefore, the inventor may not sufficiently appreciate other commercially valuable subject matter related to the inventive concept 100. Without thoroughly exploring what is potentially patentable subject matter, a patent application drafted on the initially proposed inventive concept 100 alone can be unduly narrow and can miss substantial commercial opportunities.

Other patent professionals aim to overcome the inventor's limited view of the invention by broadening the inventive concept 100 beyond the inventor's view, using logic and creativity up to but not including the prior art. Thus, these patent professionals generally attempt to capture as much inventive subject matter as possible within what they contemplate to be the field of potentially patentable subject matter 102, thereby aiming to maximize the overall value of the resulting patent. However, maximal expansion of an inventive concept 100 typically incurs higher costs in time and money associated with protracted prosecution and problematic assertion of patents with overly broad scope. Consequently, maximally expanding the inventive concept 100 can actually reduce the overall value of a patent.

The initially contemplated field of patentable subject matter 102 of an invention typically includes portions of strong commercial value in the midst of many other portions of weak commercial value. Therefore, much of the patentable subject matter covered in maximally broad patents may not have commercially value. Nevertheless, during prosecution the applicant will be drawn into fighting for claims to subject matter of little commercial value. Furthermore, the applicant may neglect to draft and defend claims of high commercial value. Consequently, patent applicants who fall victim to patent preparation techniques that do not consider an invention's markets often end up sacrificing considerable resources in exchange for little added value or even less value.

As recognized by the current method for preparing patent applications of enhanced commercial effectiveness and value, an invention market analysis can be used to create a “commercial value terrain,” which is a conceptual model for understanding the potential commercial value of various claims scopes and various claims strategies available throughout a wide landscape of potentially patentable inventive subject matter. This wide landscape of potentially patentable subject matter can include the initially contemplated field of potentially patentable subject matter 102, and possibly even territory lying outside the initially contemplated field of potentially patentable subject matter 102.

The commercial value terrain exists within the commercial value space, and this commercial value terrain contains features which indicate the specific commercial value of respective embodiments of the invention. The commercial value terrain spans the wide landscape of potentially patentable inventive subject matter and includes peaks, hills, ridges, valleys, and flatlands of the commercial value corresponding to various aspects and embodiments of the potentially patentable invention.

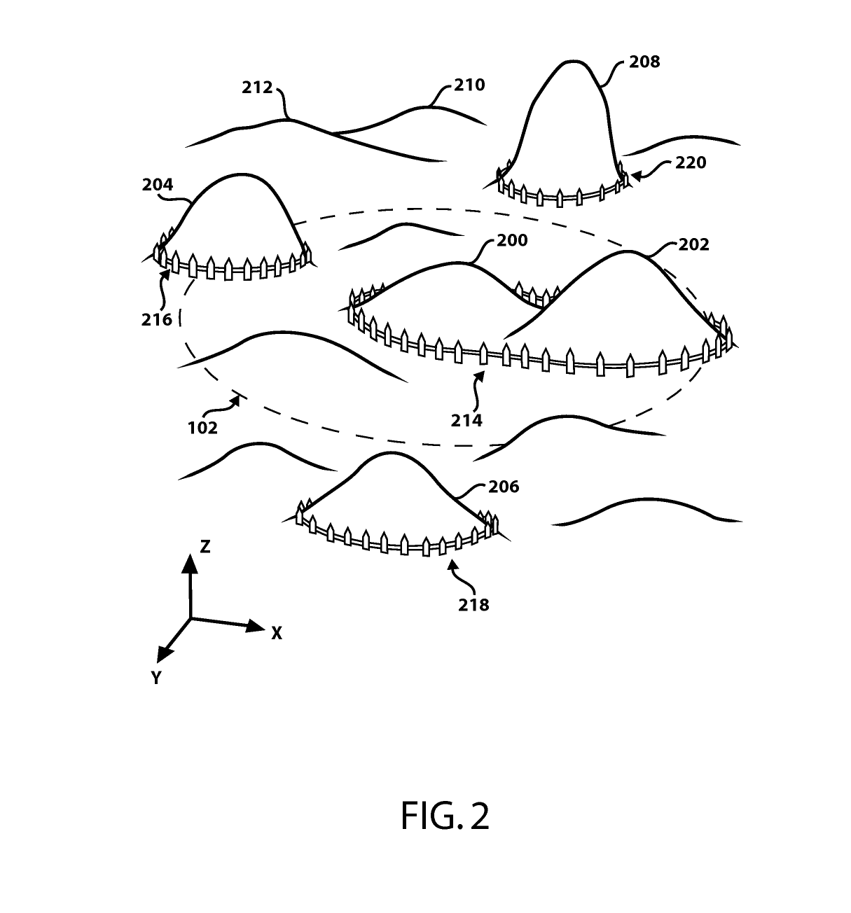

FIG. 2 is an illustration of a commercial value terrain within the commercial value space of FIG. 1, the commercial value terrain representing the commercial value of various aspects of an invention. By providing a metric of estimated commercial value of different embodiments of the invention, the commercial value terrain illustrates the relative size and strength of the potential markets of various aspects of the invention. Thus, the commercial value terrain brings to light a dimension of the invention (i.e., that of the commercial value of various possible claims scopes and embodiments of the invention) that is not traditionally studied or analyzed in a comprehensive manner for use throughout the process of patent preparation.

Invention market analysis can provide a bird's eye view of the commercial value terrain, and a careful survey of this terrain can identify all the highs and lows of the invention's commercial value. An inventor who understands this terrain is in a far greater position to make an informed decision on patent strategy. Knowledge of this terrain also enables a patent drafter to effectively fence in the hills and peaks of the invention's commercial value, without encircling the valleys or flatlands. Consequently, highly valuable aspects of the invention can be captured while its less valuable aspects are excluded.

Furthermore, an invention market analysis can also turn its gaze to commercial value terrain corresponding to inventive subject matter that extends beyond the horizons of the field of initially contemplated inventive subject matter 102. By revealing powerful markets out in the distance, invention market analysis findings can inspire unexpected reshaping of the inventive concept even outside the field of potentially patentable subject matter initially contemplated 102 by even the most high-minded patent professionals.

Therefore, patent preparation using invention market analysis can lead to effective narrowing and refining of the inventive concept, and/or effective broadening and enlarging of the inventive concept at the same time. In fact, the invention can be reshaped, redirected, subdivided, and/or displaced so dramatically as to give birth to an entirely new invention, in some cases. All of these benefits enhance the overall value of any resulting patents, while also saving time, money, and other resources.

In the embodiment shown, three hills 200, 202, 204 of commercial value terrain lying substantially within the initially contemplated field of potentially patentable subject matter 102 have been deemed worthy of patent protection, and therefore have been fenced in with claims which incorporate the subject matter of embodiments represented by the hills 200, 202, 204. In some embodiments of the present invention, separate independent claims can be used to incorporate the subject matter of each different hill. In other circumstances, subject matter corresponding to various different hills might even be claimed in entirely separate patent applications, to increase the efficiency of prosecution of each patent application.

Four other hills 206, 208, 210, 212 of commercial value terrain have been identified outside of the initially contemplated field of potentially patentable subject matter 102 as also worthy of patent protection. Two of the hills 210, 212 of commercially valuable terrain found outside the initially contemplated field of potentially patentable subject matter 102 constitute prior art, but the other two newly discovered hills 206, 208 have not been anticipated by the prior art, and therefore constitute new inventive subject matter that was inspired by an invention market analysis. Therefore, fences representing patent claims have been constructed around the hills 200, 202, 204, 206, 208 deemed worthy of patent protection and capable of being patented.

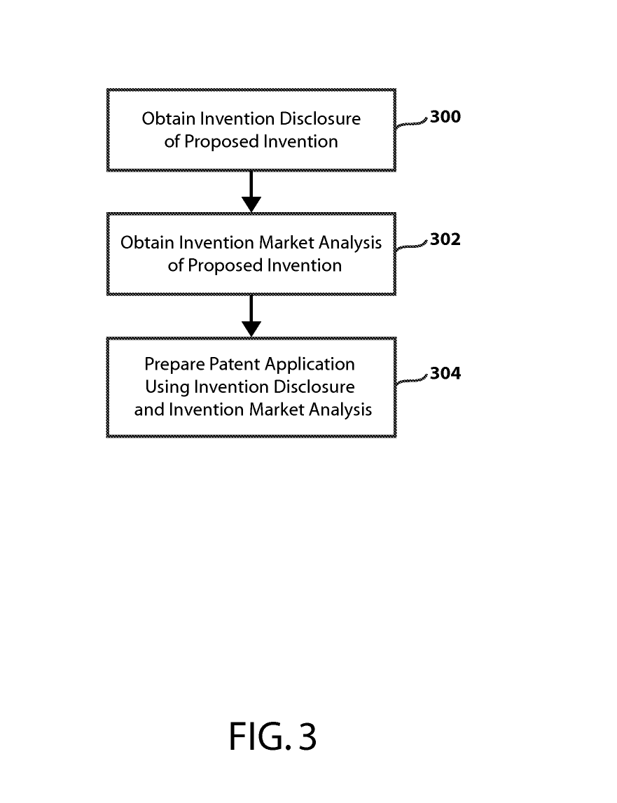

FIG. 3 is a flow diagram showing the general steps of preparing a patent application in accordance with an embodiment of the current invention. First, an invention disclosure of a proposed invention is obtained 300. Such disclosure can be provided by an inventor of the proposed invention, for example.

Next, an invention market analysis of the proposed invention is obtained 302. In some embodiments, a market professional can perform this invention market analysis 302. Invention market analysis of a proposed invention can investigate the invention's most promising markets, including both current markets as well as potential future markets. In some embodiments, such invention market analysis 302 can also take into consideration a potential direction of future research and development related to the proposed invention.

Finally, a patent application is prepared using the invention disclosure and the invention market analysis 304. In some embodiments such patent application preparation can be performed by a patent professional. In other embodiments, a non-patent-professional can prepare the patent application. In still other embodiments, a market-targeted patent application can be prepared by several people in cooperation, such as an inventor of the proposed invention, a patent professional, and/or a market professional, for example.

Preparing a patent application using invention disclosure and invention market analysis 304, so as to provide a market-targeted patent application, is a unique and unprecedented approach to preparing and drafting patent applications. This step 304 can be executed by any act or acts of patent application preparation which materially affect(s) or will materially affect the subject matter of an invention as claimed.

In some embodiments, such market-targeted patent application preparation 304 can be executed by expressing a new formulation of the invention that has been influenced by findings from invention market analysis 302. Even if invention market analysis inspires a dramatic change in scope of the proposed invention, the proposed invention disclosure is still used, at least insofar as a starting point from which changes in scope of the invention occurs.

Such market-targeted patent application preparation 304 can potentially include various key uses of the invention market analysis. For example, the patent application preparation 304 can include: creating a market-targeted patent strategy; describing the invention with a market-targeted invention description; and/or drafting market-targeted patent claims, for example. Such key components of patent application preparation can serve as a strong foundation for a patent application that is prepared using invention market analysis in addition to invention disclosure. Preparing any of a market-targeted strategy, a market-targeted invention description, and/or market-targeted patent claims, during the course of preparing a patent application, can qualify as preparing a market-targeted patent application.

A market-targeted patent strategy is a proposal for how to best describe and define the invention in such a way as to protect it in its key markets, as identified and/or forecast during invention market analysis. In some embodiments, the market-targeted patent strategy can have a strong bearing on the claims of the market-targeted patent application. For example, a market-targeted patent strategy can suggest which markets the application's claims should be geared towards, which in turn will affect how the invention is claimed.

In other instances, the market-targeted patent strategy can influence which embodiments of the invention are described, and/or how embodiments are described, and/or what is considered the “best mode” of the invention (the best way to make and use the invention). Even if claims are not edited in light of invention market analysis, other parts of the application's specification, which help clarify the scope and subject matter of the claims, can be edited. In other embodiments, the market-targeted patent strategy can lay out how to approach other sections of the patent application, such as the title, field, background, summary, drawings, brief description of the drawings, detailed description, and abstract, for example.

For example, the market-targeted patent strategy can suggest that the application's title include certain language indicating how the invention is well suited for its strongest market. As another example, the field of the invention can be influenced by a market-targeted patent strategy which draws upon an invention market report's explanation of what the strongest markets are for an invention. As yet another example, the market-targeted patent strategy can influence the background section, by explaining the disadvantages inherent in prior art, versus the benefit conferred by the invention as applied to certain key markets.

A market-targeted invention description is a summary description of the invention, which is enhanced by invention market analysis findings and describes the invention in such a way as to protect in its key markets. The market-targeted invention description can describe the invention in more concrete terms than the market-targeted patent strategy typically would. For example, the market-targeted invention description can describe the main elements and sub-elements of the invention which are seen as representing its core novelty, and which would serve as the basis for independent and/or broad claims; and other elements and sub-elements which can be the basis for dependent claims.

Finally, market-targeted patent claims are claims specifically defining the scope of the invention, which have been informed by insights gleaned from invention market analysis, and which are directed towards the invention's most promising markets. The market-targeted claims precisely define the invention in the appropriate formal and legal patent language. Therefore, these market-targeted patent claims express the invention in a clearer and more definite form than do the market-targeted description and market-targeted patent strategy.

Market-targeted patent claims provide a strong foundation for a patent application that is directed towards an invention's most appropriate markets. Claims define the metes and bounds of the invention for which patent protection is being pursued. The claims serve as the foundation upon which the remainder of the patent application is built. Market-targeted claims therefore ensure that the subject matter of the application is directed towards the invention's strongest markets.

Information obtained during invention market analysis of a proposed invention can be used in preparing a patent application 304 in various other ways. For example, the scope of the invention can change, including being reshaped, shifted, and/or possibly subdivided into several inventions. Invention market analysis can also support a change in patent strategy, and it can also inform the work on any given portion of a patent application.

In some embodiments, preparation of a patent application using invention market analysis of a proposed invention in addition to invention disclosure 304 can also include using information obtained during invention market analysis as a guide in writing the full patent application. In other embodiments, such patent application preparation using invention market analysis 304 can include incorporating information obtained during the invention market analysis directly into the written patent application.

Many parts of a patent application can be influenced by information obtained from invention market analysis, directly or indirectly, and for a variety of reasons. For example, invention market analysis can influence the way an invention is described in detail, so as to highlight its benefits in a particular market. Furthermore, some parts of the application can be influenced by insights gleaned from the invention market analysis, for example as to how the invention differs from, or offers improvements over, prior art, or how it otherwise provides strong benefit in particular market sectors.

In some embodiments, patent claims scope can be guided by information obtained from invention market analysis. For example, each market identified through invention market analysis on a proposed invention potentially can be represented by its own independent claim. Various other strategies can be used, such as changing the scope of an independent claim so as to encompass multiple markets, or a specific sub-market, for example.

As mentioned, the proposed invention itself may also change based upon information obtained from invention market analysis of the proposed invention 302. In some embodiments, the scope of an invention may be reformed based upon information obtained during invention market analysis 302. For example, the scope of the invention may be narrowed, broadened, or redirected. In other embodiments, the invention may even be bifurcated or subdivided in some other manner.

In still other embodiments, the scope of the invention can essentially be displaced, bearing only a trace resemblance or perhaps essentially no resemblance at all, to the initially proposed invention. In some embodiments, the displaced invention may retain certain qualities of the initially proposed invention and/or relate to the initially proposed invention on an abstract level; but the displaced invention may otherwise be a completely new invention, having different structure and/or function, and/or being geared towards a completely different market. Naturally, this change in the invention based on market considerations can have a direct and important bearing on the preparation of the patent application 304.

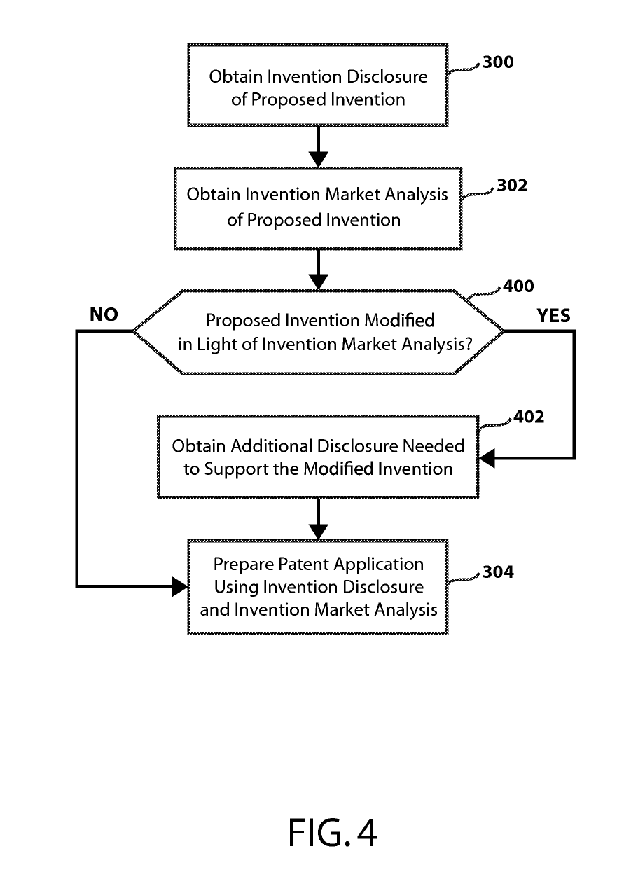

FIG. 4 is a flow diagram showing the general steps of preparing a patent application in accordance with an embodiment of the current invention, including obtaining additional disclosure according to modifications made in light of invention market analysis. First, an invention disclosure of a proposed invention is obtained 300, and then an invention market analysis of the proposed invention is obtained 302. If the proposed invention has not been modified in light of the invention market analysis 400, then a patent application can be prepared using the invention disclosure and the invention market analysis 304.

However, if the proposed invention has been modified in light of the invention market analysis 400, then additional disclosure needed to support the modified invention is obtained 402. It should be noted that in some situations, the invention may be so radically altered by choices motivated by the invention market analysis, that it may bear little resemblance to the initially proposed invention. Considerable new disclosure could be required in such instances. Upon obtaining the appropriate new disclosure, a patent application is prepared using the invention disclosure and the invention market analysis 304.

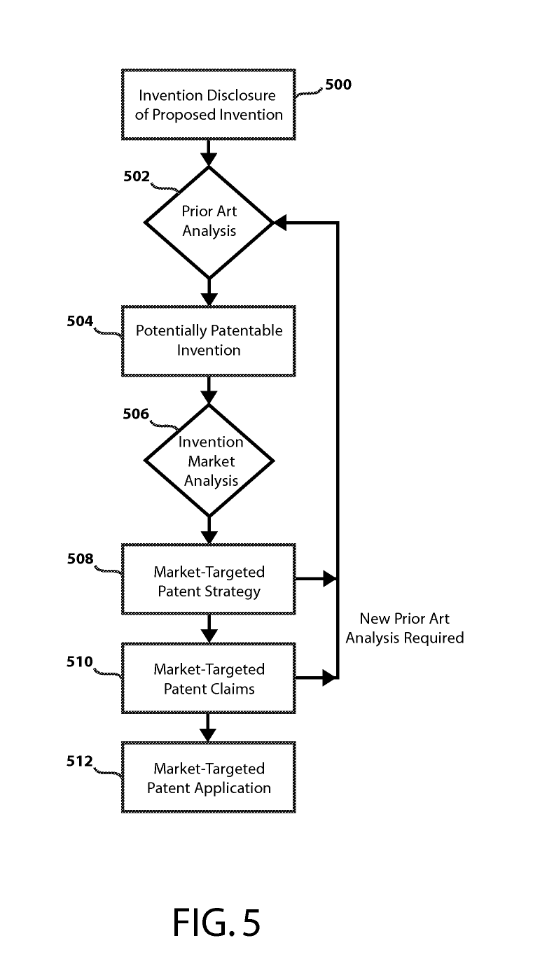

FIG. 5 is a flow diagram showing the steps of an embodiment of the invention, wherein the invention undergoes prior art analysis before undergoing invention market analysis. In this embodiment, the invention is clarified by the prior art analysis before undergoing invention market analysis. Invention disclosure of a proposed invention 500 is first obtained, and prior art analysis 502 is performed upon the proposed invention 500.

Based upon the results of the prior art analysis 502, in some embodiments a potentially patentable 504 invention can be identified. The potentially patentable invention 504 can be a newly described invention according to what seems patentable in light of the prior art analysis 502. In this embodiment, the potentially patentable invention 504 can be considered a newly proposed invention which will undergo invention market analysis.

Invention market analysis 506 performed upon the potentially patentable proposed invention 504 is then obtained. A patent application can then be prepared, using the invention disclosure 500 and invention market analysis 506. In the embodiment shown, a market-targeted patent strategy 508 is provided. The market-targeted patent strategy 508 is a patent strategy that is influenced by information obtained from invention market analysis 506.

A market-targeted patent strategy 508 is a proposal for how to best describe and define the invention in such a way as to protect it in its key markets, as identified and/or forecast during invention market analysis 506. In some embodiments, the market-targeted patent strategy 508 can have a strong bearing on the claims of the market-targeted patent application. For example, a market-targeted patent strategy 508 can suggest which markets the application's claims should be geared towards, which in turn will affect how the invention is claimed.

In other instances, the market-targeted patent strategy 508 can influence which embodiments of the invention are described, and/or how embodiments are described, and/or what is considered the “best mode” of the invention (the best way to make and use the invention). Even if claims are not edited in light of invention market analysis 506, other parts of the application's specification, which help clarify the scope and subject matter of the claims, can be edited. In other embodiments, the market-targeted patent strategy 508 can lay out how to approach other sections of the patent application, such as the title, field, background, summary, drawings, brief description of the drawings, detailed description, and abstract, for example.

For example, the market-targeted patent strategy 508 can suggest that the application's title include certain language indicating how the invention is well suited for its strongest market. As another example, the field of the invention can be influenced by a market-targeted patent strategy 508 which draws upon invention market analysis 506 explanation of what the strongest markets are for an invention. As yet another example, the market-targeted patent strategy 508 can influence the background section, by explaining the disadvantages inherent in prior art, versus the benefit conferred by the invention as applied to certain key markets.

In the embodiment shown, the market-targeted patent strategy 508 can be used as the basis for market-targeted claims 510. Market-targeted patent claims 510 are claims specifically defining the scope of the invention, which have been informed by insights gleaned from invention market analysis 506, and which are directed towards the invention's most promising markets. The market-targeted claims 510 precisely define the invention in the appropriate formal and legal patent language. Therefore, these market-targeted patent claims 510 express the invention in a clearer and more definite form than the market-targeted patent strategy 508.

After invention market analysis 506, further searching may be required, due to new inventive matter inspired by invention market analysis 506, for example. If further searching is required, the invention as disclosed in the market-targeted patent strategy 508 and/or market-targeted patent claims 510 can undergo prior art analysis 502 once again 510. In the embodiment shown, further prior art analysis 502 can occur at either the stage of the market-targeted patent strategy 508, or the stage of the market-targeted claims 510.

The test for whether new prior art analysis 502 is required, is whether the market-targeted patent strategy 508 and/or market-targeted patent claims 510 relate to subject matter not considered in previous prior art analysis 502? If so, further prior art analysis 502 is appropriate, and can be performed again.

In the embodiment shown, if prior art analysis 502 is repeated, then invention market analysis 506 is also performed again. Another invention market analysis 506 can be useful, for example if the inventive concept has been broadened in light of new prior art analysis 502. If new prior art analysis 502 results in a new potentially patentable invention which relates to subject matter not considered in previous invention market analysis 506, then further invention market analysis 506 can be appropriate.

The embodiment shown is an iterative process. This helps ensure that a proposed invention has been refined and geared towards its most promising markets as thoroughly as possible, both in light of prior art analysis 502, as well as invention market analysis 502. A market-targeted patent application 512 is then prepared, when no further prior art analysis is required. In alternative embodiments, invention market analysis 502 is not necessarily performed again.

In other embodiments, a market-targeted patent application 512 can be prepared using invention disclosure and invention market analysis, without drafting market-targeted patent claims 510. However, market-targeted patent claims 510 can provide a strong foundation for a patent application that is directed towards the most appropriate markets for the invention to be covered in the application. Claims define the metes and bounds of the invention for which patent protection is being pursued. Market-targeted claims 510 therefore help ensure the application is directed towards the invention's strongest markets.

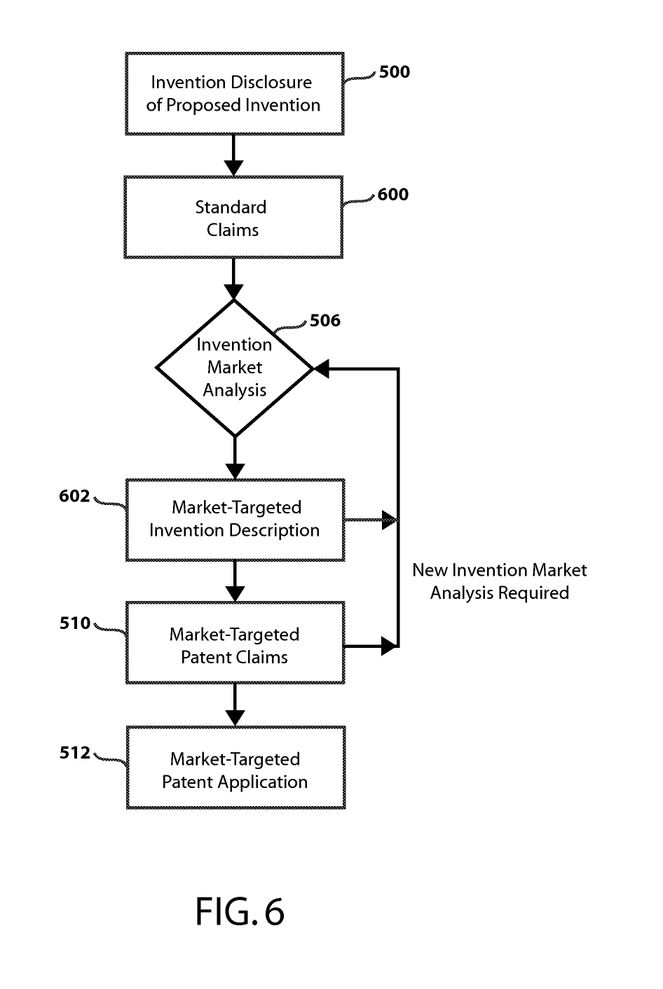

FIG. 6 is a flow diagram showing the steps of an embodiment of the invention, wherein the patent application is informed by both standard claims and market-targeted claims. In this embodiment, the invention is clarified by these standard claims before undergoing invention market analysis. Invention disclosure of a proposed invention is first obtained 500. Next, standard patent claims 600 describing the proposed invention using the invention disclosure 500, 504 are drafted. Standard claims 600 are claims that are typically drafted in patent practice, that is, claims which have not been informed by invention market analysis.

Invention market analysis 506 that is performed on the invention using the standard claims 600 is then obtained. A patent application can then be prepared using the invention disclosure 500 and invention market analysis 506. In the embodiment shown, a market-targeted invention description 602 is provided. The market-targeted invention description 602 is an invention description that is influenced by information obtained from the invention market analysis 506.

A market-targeted invention description 602 is a summary description of the invention, which is enhanced by invention market analysis 506 findings and describes the invention in such a way as to protect in its key markets. The market-targeted invention description 602 can describe the invention in more concrete terms than the market-targeted patent strategy 508 typically would.

For example, the market-targeted invention description 602 can describe the main elements and sub-elements of the invention which are seen as representing its core novelty, and which would serve as the basis for independent and/or broad claims; and other elements and sub-elements which can be the basis for dependent claims.

In the embodiment shown, the market-targeted invention description 602 can be used as the basis for drafting market-targeted patent claims 510. A market-targeted patent application 512 is finally drafted using the market-targeted patent claims 510. Further invention market analysis 506 may be required, however, due to new inventive matter inspired by previous invention market analyses 506, for example.

If further invention market analysis 506 is required, the market-targeted invention description 602 and/or market-targeted patent claims 510 can undergo prior art analysis 506 once again. For example, if new matter is introduced into the market-targeted invention description 602 and/or market-targeted patent claims 510, invention market analysis 506 can be performed again.

The test for whether invention market analysis 506 should be performed again, is whether the market-targeted invention description 602 and/or market-targeted claims 510 relate to subject matter not considered in previous invention market analyses? If so, further invention market analysis 506 is appropriate, and can be performed again. In the embodiment shown, further invention market analysis 506 can occur at either the stage of the market-targeted invention description 602, or the stage of the market-targeted claims 510.

The embodiment shown is a repetitive process in a few ways. This helps ensure that a proposed invention has been refined and geared towards its most promising markets as thoroughly as possible, through both an initial set of standard claims 600, as well as a later set of market-targeted claims 510. This embodiment is also repetitive in allowing for extra invention market analysis 506 when appropriate, so as to ensure that any and all new matter introduced will undergo invention market analysis 506 just as the initial invention disclosure 500 does.

Drafting standard claims 600 before invention market analysis 506, as well as drafting market-targeted claims 510 after invention market analysis 506, can be a powerful strategy. Claims define the metes and bounds of the invention for which patent protection is being pursued. Therefore, providing standard claims 600 before invention market analysis 506 allows invention market analysis 506 to be performed on a concrete and well-defined proposed invention.

The two-stage claims drafting procedure also enables the invention as inspired by invention market analysis 506 to be defined with precision both before and after invention market analysis 506, which can help when preparing a patent application directed towards an invention's strongest identified markets. In some embodiments, the market-targeted patent application 512 that is ultimately prepared can include standard claims 600 as well as market-targeted patent claims 510, thereby fortifying patent protection of the invention on multiple levels.

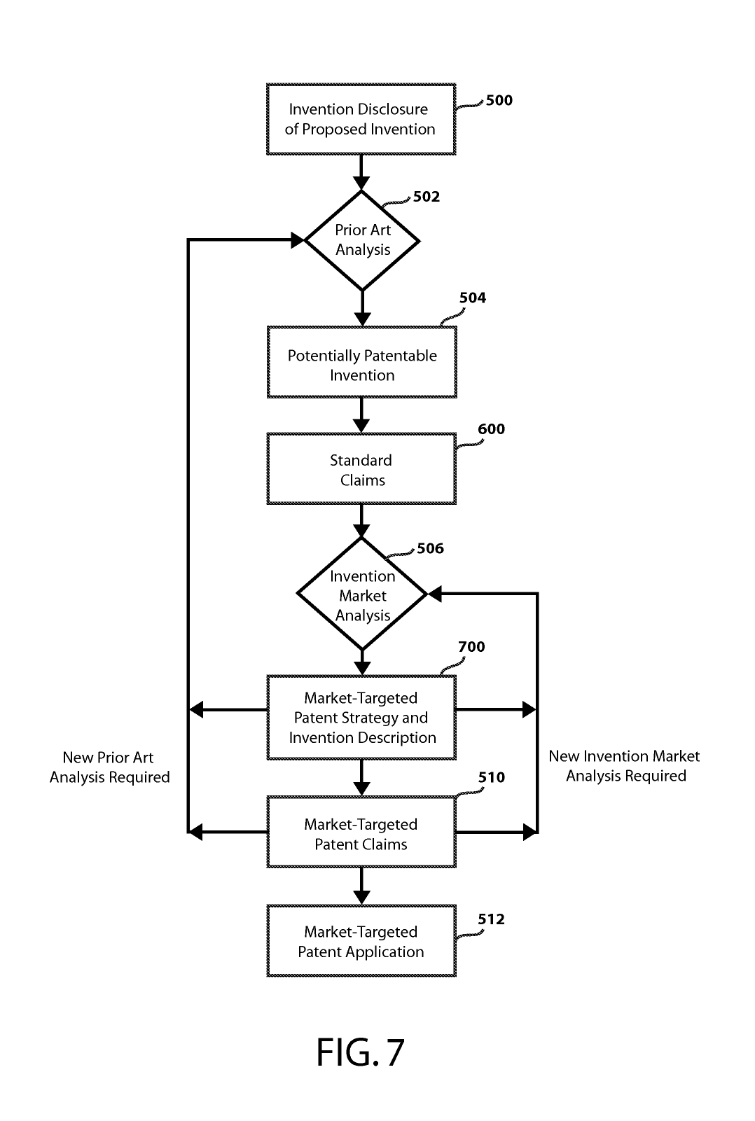

FIG. 7 is a flow diagram showing the steps of an embodiment of the invention, wherein the invention undergoes prior art analysis before undergoing invention market analysis, and wherein the patent application is informed by both standard claims and market-targeted claims.

Invention disclosure of a proposed invention 500 is obtained, and prior art analysis 502 is performed upon the proposed invention 500. Based upon the results of the prior art analysis 502, a potentially patentable invention 504 can be identified.

Next, standard patent claims 600 that are drafted on the potentially patentable proposed invention 504 are obtained. Standard claims 600 are claims as they are typically drafted in patent practice, that is, claims which have not been informed by invention market analysis. In this embodiment, therefore, the invention is clarified by both prior art analysis 502 and standard claims 600, before undergoing invention market analysis 306.

Invention market analysis 506 is then obtained, the invention market analysis having been performed on the invention using the standard claims 600 as a guide. A patent application can then be prepared using the invention disclosure 500, 504 and invention market analysis 506. In the embodiment shown, a market-targeted patent strategy and market-targeted invention description 700 are then provided.

The market-targeted patent strategy and market-targeted invention description 700 can be influenced by, and/or directly incorporate, information obtained from invention market analysis 506. Preparing both a market-targeted patent strategy and a market-targeted invention description 700 can help keep the patent application preparation process directed towards the invention's appropriate markets, in a progressive series of steps leading up to the drafting of claims.

In the embodiment shown, the market-targeted patent strategy and invention description 700 are then used as the basis for drafting market-targeted patent claims 510. Market-targeted patent claims 510 that are drafted using a market-targeted patent strategy and a market-targeted invention description 700 can reap the benefits of a market-centered approach that is executed on several levels of detail.

Using a market-targeted patent strategy and invention description 700 to aid in drafting market-targeted patent claims 512 also helps ensure that attention is paid to the invention's important markets, at multiple levels of detail, and at each successive stage of patent planning and preparation.

A market-targeted patent application 512 is finally drafted, using the market-targeted patent claims 510. A market-targeted patent application 512 drafted prepared with a market-targeted patent strategy and a market-targeted invention description 700, as well as market-targeted patent claims 510, can efficiently be guided towards the invention's most promising markets with great insight and precision.

If new matter is introduced into the market-targeted patent strategy and/or invention description 700, and/or the market-targeted patent claims 510, invention market analysis 506 can be performed once again. The test for whether invention market analysis 506 should be performed again, is whether the market-targeted patent strategy and invention description 700, and/or the market-targeted claims 510, relate to subject matter not considered in previous invention market analyses? If so, invention market analysis 506 can be performed again.

Repeated invention market analysis 506 can occur at either the stage of the market-targeted patent strategy and market-targeted invention description 700, and/or the stage of the market-targeted patent claims 510. Invention market analysis 506 can be repeated at any stage where the invention has been modified so as to relate to subject matter not considered in previous invention market analyses 506.

On the other hand, further prior art searching and prior art analysis 502 may be required, due to a change in scope and/or subject matter of the invention in the course of providing a market-targeted patent strategy and invention description 700, and/or the drafting of market-targeted patent claims 510, for example.

An appropriate test to determine whether further prior art analysis 502 is required, is whether the market-targeted patent strategy and invention description 700, and/or the market-targeted claims 510, relate to subject matter not considered in the previous prior art analysis 502? If so, new prior art analysis 502 is appropriate.

If further searching is required, the invention undergoes prior art analysis 502 once again. This iterative process can help ensure that the potentially patentable invention 504, as further clarified through a market-targeted patent strategy and market-targeted invention description 700, and/or market-targeted claims 510, has been fully informed by prior art analysis 502. In this embodiment, further prior art analysis 502 can occur at either the stage of the market-targeted patent strategy and invention description 700, or at the stage of the market-targeted patent claims 510.

The embodiment shown is an iterative process. This helps ensure that a proposed invention has been refined and geared towards its most promising markets as thoroughly as possible, both in light of prior art analysis 502, as well as invention market analysis 506.

This repetitive process also helps ensure that a proposed invention has been refined and geared towards its most promising markets as thoroughly as possible, through both an initial set of standard claims 600, as well as a later set of market-targeted claims 510.

Drafting standard claims 600 before invention market analysis 506, in addition to drafting market-targeted claims 510 after invention market analysis 506, can be a powerful strategy. Claims define the metes and bounds of the invention for which patent protection is being pursued. Therefore, providing standard claims 600 before invention market analysis 506 allows the invention market analysis 506 to be performed on a concrete and well-defined proposed invention.

The two-stage claims drafting procedure also enables the invention as inspired by invention market analysis 506 to be defined with precision, which can help when preparing a patent application directed towards an invention's strongest identified markets. In some embodiments, the market-targeted patent application 512 ultimately can include standard claims 600 as well as market-targeted patent claims 510, thereby fortifying patent protection of the invention on multiple levels.

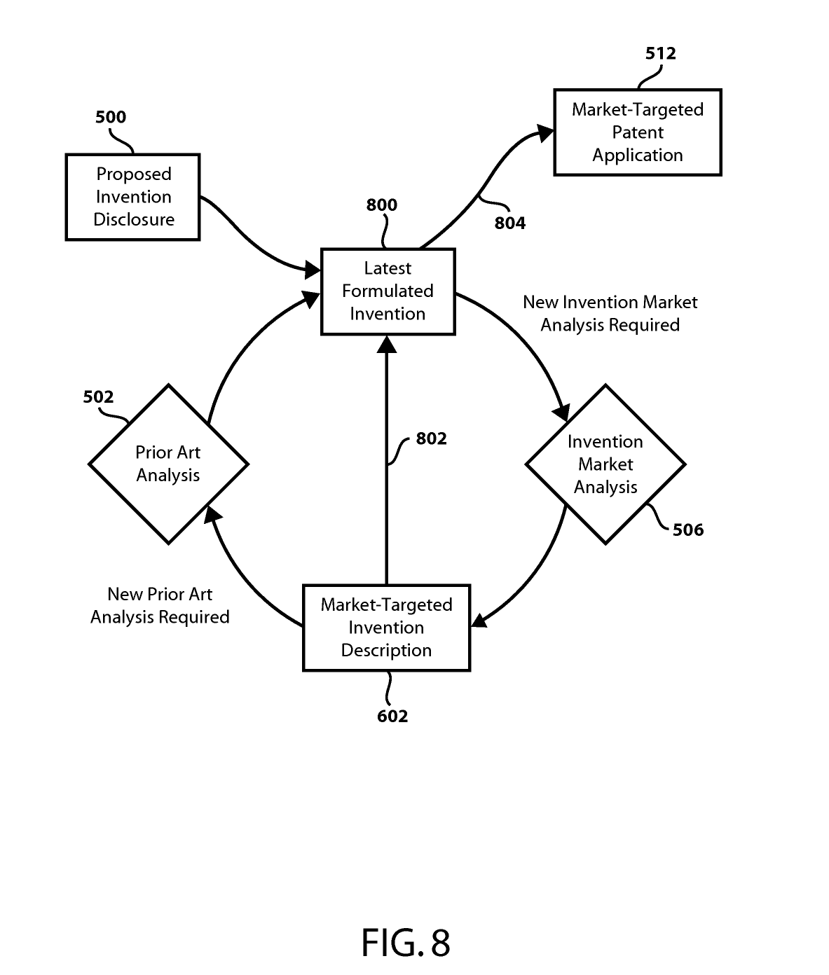

FIG. 8 is a cyclical flow diagram showing the steps of an embodiment of the invention, wherein preparation of the patent application includes providing an invention market analysis, a market-targeted description, and prior art analysis. First, invention disclosure of a proposed invention 500 is obtained. Such disclosure 500 can be provided by an inventor of the proposed invention, for example.

According to the diagram shown, at this stage the proposed invention is considered the latest formulated invention 800. However, this latest formulated invention 800 can undergo changes in scope and/or subject matter as a result of invention market analysis 506, market-targeted invention description 602, and/or prior art analysis 502. The latest formulated invention 800 first undergoes invention market analysis 506.

An invention market analysis 506 of the latest formulated invention 800 is obtained, if subject matter of the latest formulated invention 800 has not been considered by previous invention market analysis 506. In some embodiments, a market professional can perform this invention market analysis 506. Such invention market analysis 506 can consider current and potential future markets, and in some embodiments can take into consideration potential direction(s) of future research and development related to the latest formulated invention 800. Subsequent to invention market analysis 506, the latest formulated invention 800 can potentially be reshaped in a fundamental way, thereby giving rise to a new version of the latest formulated invention 800.

In the embodiment shown, an invention market description 602 is provided, influenced by the findings of invention market analysis 804. The market-targeted invention description 602 is an invention description that is influenced by information obtained from the invention market analysis 506.

A market-targeted invention description 602 is a summary description of the invention, which is enhanced by invention market analysis 506 findings and describes the invention in such a way as to protect in its key markets.

For example, the market-targeted invention description 602 can describe the main elements and sub-elements of the invention which are seen as representing its core novelty, and which would serve as the basis for independent and/or broad claims; and other elements and sub-elements which can be the basis for dependent claims.

If new prior art analysis is required, the latest formulated invention as described by the market-targeted invention 602 undergoes prior art analysis 502. In the embodiment shown, the test for whether prior art analysis 502 is required, is whether the invention market analysis 506 and/or market-targeted invention description 602 relate to subject matter not considered in previous prior art analysis 502? If so, prior art analysis 502 is appropriate, and should be performed. If all subject matter of the latest formulated invention 800, including subject matter introduced by invention market analysis 506 and/or the market-targeted invention description 602, has already been considered by previous prior art analysis 502, then no new prior art analysis is required 802.

Next, the latest formulated invention 800 undergoes further market analysis 506 if appropriate. The test for whether further invention market analysis 506 is required, is whether the latest formulated invention 800 relates to subject matter not considered in previous invention market analysis 506? If so, further invention market analysis 506 is appropriate, and should be performed. If all subject matter of the latest formulated invention 800, including subject matter introduced by previous invention market analysis 506, market-targeted invention description 602, and/or prior art analysis 502, then no new market analysis is required 804.

If no new invention market analysis 506 or prior art analysis 502 are required, then the latest formulated invention 800 can serve as the direct basis for preparing a market-targeted patent application 512. In the embodiment shown, after sufficient invention market analysis 506 and prior art analysis 502 have been performed, a market-targeted patent application 512 is prepared, using the latest formulated invention 800 inspired by previous invention market analysis 506, market-targeted invention description 602, and prior art analysis 502.

In some embodiments, market-targeted patent claims can be drafted based upon the latest formulated invention 800. In such embodiments, the market-targeted claims can be used as the basis for the market-targeted patent application 512.

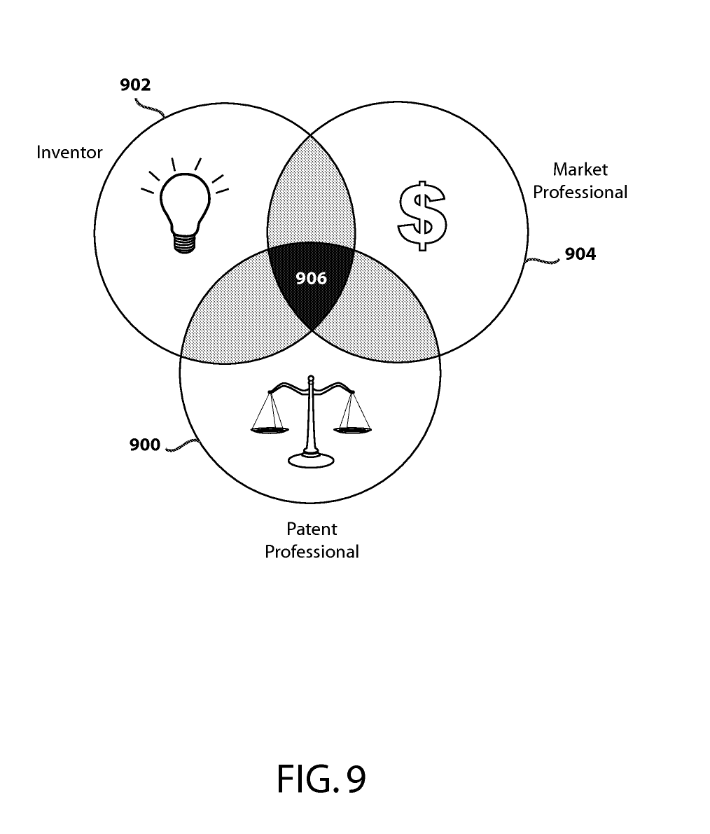

FIG. 9 is a set diagram showing the overlapping and converging expertise offered by a patent professional, an inventor, and a market professional, in preparing a patent application inspired by findings from invention market analysis. This diagram illustrates the synergy provided by the patent expertise 900 of a patent professional, the technical expertise 902 of an inventor, and the market expertise 904 of a market professional. The overlap and convergence 906 of these different types of expertise give rise to a synergistic cooperation that yields valuable results.

The respective expertise of a patent professional 900, an inventor 902, and a market professional 904 provide different points of view which, when combined, are greater than their sum. Patent applications prepared using invention market analysis take advantage of a mutually reinforcing, synergistic effect between considering legal 900 and technical 902 issues, as well as considering commercial possibilities 904, at the same time.

In considering an invention's commercial possibilities, new legal 900 and technical 902 possibilities may be revealed. Conversely, when considering an invention's legal 900 and technical 902 possibilities, new commercial possibilities 904 may be revealed. Therefore, in preparing a patent application while addressing all three of these issues (legal 900, technical 902, and commercial 904) in the same integrative process, an invention can be commercialized more efficiently than if only one or two of these considerations are addressed at a time.

In some instances, the patent professional 900 and/or inventor 902 themselves may have sufficient market expertise 904 to bring important market considerations to the table when preparing a patent application. For example, in some embodiments a patent professional 900 and/or an inventor 902 may also be a market professional 904 capable of performing a professional invention market analysis. In other embodiments, a separate market professional 904 can be responsible for certain tasks related to considering the commercial aspects of the invention 904, such as performing an invention market analysis, providing a market report, and/or gleaning insights from invention market analysis.

A patent application prepared not only with an eye towards legal 900 and technical 902 concerns, but also with an eye towards business and market concerns 904, can take better advantage of various markets of the invention that may not typically occur to someone who is not market-savvy. Such market consideration can also lead to new inventive and/or patenting insights, thereby expanding the scope of the invention.

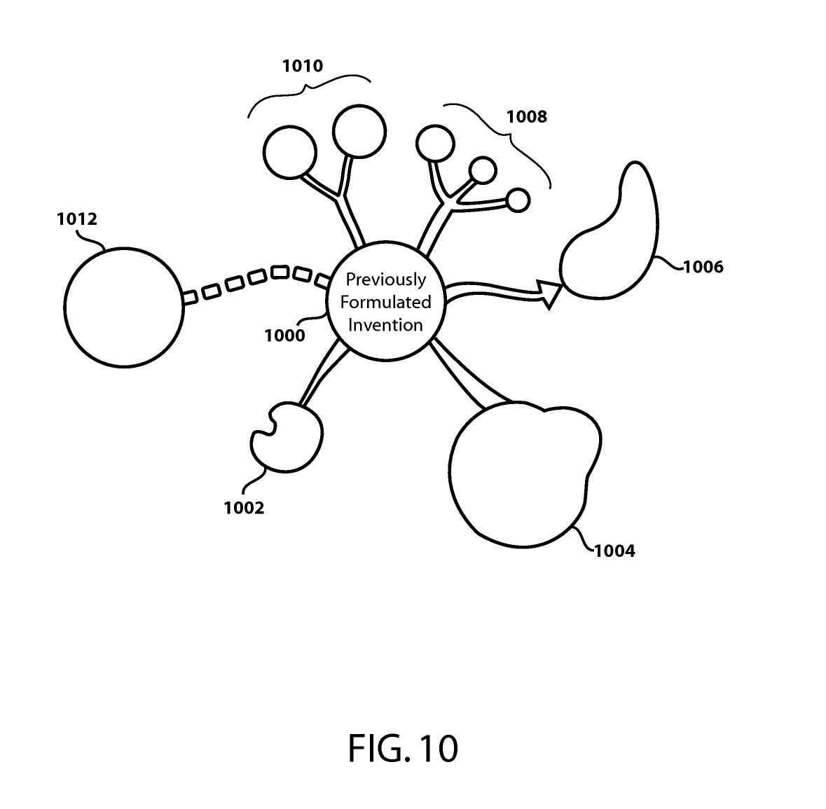

Professional consideration of market issues 904 can merge with consideration of technical issues 902 and legal issues 900 in a way that also helps to change the scope of an invention so as to maximize the commercial value of the invention. Various possibilities for changing the scope of the invention can be suggested, such as reshaping, shifting, and/or subdividing the scope of the invention. These possible changes to inventive scope are discussed in greater detail in connection with FIG. 10.

In some embodiments, preparation of a market-targeted patent application can include brainstorming between an inventor, a patent professional, and a market professional, giving rise to the real-time overlapping and convergence 906 of their respective levels of expertise. In this case, the expertise of each participant can help to expand the horizons of the expertise of the others, thereby shedding light on new commercial possibilities as well as new inventive and/or patenting possibilities.

FIG. 10 is an illustration of various embodiments of the reshaping of an invention in light of invention market analysis. At a given point in the preparation of a patent application, an invention is formulated. For the purposes of this figure, a previously formulated invention 1000 can be the initially proposed invention, or a change, or “reformulation,” of the initially proposed invention. For example, a previously formulated invention 1000 could be a potentially patentable invention identified in light of prior art analysis of an earlier proposed invention.

The previously formulated invention 1000 then undergoes invention market analysis, at which point the previously formulated invention 1000 can potentially be changed or reformulated in light of invention market analysis. For example, invention market analysis can give rise to a market-targeted patent strategy, a market-targeted invention description, and/or a set of market-targeted patent claims, which in turn can reformulate the previously formulated invention 1000 into an invention with new subject matter and/or new scope, through such actions as narrowing 1002, broadening 1004, redirecting 1006, trifurcating 1008, bifurcating 1010, and/or displacing 1012 the scope of the invention.

In some embodiments, the scope of an invention may be reshaped, such as narrowed 1002, and/or broadened 1004. The previously formulated invention can also be shifted into a new market, such as being redirected 1006 or fully displaced 1012. The previously formulated invention can also be subdivided, such as being bifurcated 1010 or trifurcated 1008.

A previously formulated invention 1000 which undergoes a redirection 1006 of its scope can still retain at least a portion of its original subject matter, while at the same time also incorporating new subject matter that pertains to a newly discovered market, for example.

Invention redirection 1006 can occur when the scope or subject matter of the invention is re-focused, such as by being directed into other markets highlighted during invention market analysis, for example. For an invention that has been directed 1006 into other markets, new inventive subject matter has been introduced which is commercially valuable in those other markets. This new inventive subject matter can be beyond the scope of the previously formulated invention 1000.

In other embodiments, the previously formulated invention 1000 can also be subdivided in some manner, such as by being bifurcated 1010 or trifurcated 1008, thereby giving birth to separate different inventions. Some of these new sub-inventions might bear little to no resemblance to the previously formulated invention 1000, for example if they are directed to completely new markets and therefore have totally different subject matter.

In still other embodiments, the previously formulated invention 1000 may be so radically altered as a result of invention market analysis, that the changed invention with shifted scope bears little resemblance to the previously formulated invention 1000 except on an abstract level, or it may not resemble the previously formulated invention 1000 at all. In such instances, the scope of the previously formulated invention 1000 is so radically shifted, that it can be said to be essentially displaced 1012. The displaced invention 1012 can be radically different from the latest formulated invention 1000 and contain essentially entirely different subject matter, for example due to having been applied to a completely new market.

As an example, in some embodiments the displaced invention 1012 can be an altogether new invention than the previously formulated invention 1000, and/or it can have different structure and/or function, and/or can be geared towards a completely different market. Naturally, such radical change in invention based on invention market analysis findings can have a direct and important bearing on the preparation of a patent application. This change in invention can either occur as a result of, or may be expressed through, a new market-targeted patent strategy, market-targeted invention description, and/or market-targeted patent claims, for example.

In all cases, regardless of how much a previously formulated invention 1000 is or is not changed, the previously formulated invention 1000 disclosure would be used at least as the basis for determining how best to change the previously formulated invention 1000 in light of invention market analysis findings.

The essence of the current method for preparing a market-targeted patent application is to use both invention disclosure, and invention market analysis, to target a patent application towards the markets deemed most promising for the invention. While this method possibly includes considerable changing or reformulation of the scope of the invention itself, the original invention disclosure is nonetheless used as a starting point for invention changing or reformulation.

There are many methods through which the scope and/or subject matter of an invention can be changed, when considering the findings of invention market analysis performed for that invention. The insights gleaned from invention market analysis can be used in the ways described here, or other ways apparent to one of ordinary skill in the art of patent preparation, when preparing a patent application directed towards its strongest markets.

Other modifications and implementations will occur to those skilled in the art without departing from the spirit and the scope of the invention as claimed. Accordingly, the above description is not intended to limit the invention except as indicated in the following claims.

What is claimed is:

1. A method for preparing a market-targeted patent application of enhanced commercial effectiveness and value, the method comprising:
obtaining an invention disclosure of a proposed invention;
obtaining an invention market analysis of the proposed invention, the invention market analysis being performed using the invention disclosure of the proposed invention; and
preparing a patent application using:
the invention disclosure of the proposed invention; and
the invention market analysis of the proposed invention.

2. The method of claim 1, wherein before the invention market analysis is performed, the proposed invention is clarified by at least one of:
analyzing known prior art so as to ascertain a potentially patentable scope of the proposed invention in light of the known prior art; and
drafting a set of standard patent claims so as to define a potentially patentable scope of the proposed invention in light of the invention disclosure.

3. The method of claim 1, wherein results of the invention market analysis of the proposed invention are provided in a market report, the market report including at least one of:
an objective professional study; and
an informed subjective professional opinion.

4. The method of claim 1, further comprising:
before preparing the patent application, and
if the proposed invention has been modified before or during invention market analysis, thereby providing a modified invention, and
if the modified invention needs additional disclosure to support claims to the modified invention,
obtaining additional disclosure needed to support the claims to the modified invention.

5. The method of claim 1, further comprising:
before preparing the patent application, and
if the proposed invention has been modified before or during invention market analysis, thereby providing a modified invention, and
if the modified invention requires analysis of known prior art so as to ascertain a potentially patentable scope of the modified invention,
analyzing known prior art so as to ascertain a potentially patentable scope of the modified invention in light of the known prior art.

6. The method of claim 1, wherein at least one of:
the invention market analysis; and
preparing the patent application so as to provide a market-targeted patent application,
is performed by at least one of:
an inventor of the proposed invention;
a market professional; and
a patent professional.

7. The method of claim 1, wherein preparing the patent application includes at least one of:
creating a patent strategy in light of the invention market analysis of the proposed invention, so as to provide a market-targeted patent strategy;
describing the proposed invention in light of the invention market analysis of the proposed invention, so as to provide a market-targeted invention description; and
drafting patent claims in light of the invention market analysis of the proposed invention, so as to provide market-targeted patent claims.

8. The method of claim 1, wherein preparing the patent application includes using the invention market analysis of the proposed invention to perform at least one of:
reshaping the scope of the proposed invention;
narrowing the scope of the proposed invention;
broadening the scope of the proposed invention;
shifting the scope of the proposed invention;
redirecting the scope of the proposed invention;
displacing the scope of the proposed invention;
subdividing the proposed invention;
bifurcating the proposed invention; and
trifurcating the proposed invention.

9. A market-targeted patent application of enhanced commercial effectiveness and value, the application produced by the method comprising:
obtaining an invention disclosure of a proposed invention;
obtaining an invention market analysis of the proposed invention, the invention market analysis being performed using the invention disclosure of the proposed invention; and
preparing a patent application using:
the invention disclosure of the proposed invention; and
the invention market analysis of the proposed invention.

10. The application of claim 9, wherein before the invention market analysis is performed, the proposed invention is clarified by at least one of:
analyzing known prior art so as to ascertain a potentially patentable scope of the proposed invention in light of the known prior art; and
drafting a set of standard patent claims so as to define a potentially patentable scope of the proposed invention in light of the invention disclosure.

11. The application of claim 9, wherein results of the invention market analysis of the proposed invention are provided in a market report, the market report including at least one of:
an objective professional study; and
an informed subjective professional opinion.

12. The application of claim 9, further comprising:
before preparing the patent application, and
if the proposed invention has been modified before or during invention market analysis, thereby providing a modified invention, and
if the modified invention needs additional disclosure to support claims to the modified invention,
obtaining additional disclosure needed to support the claims to the modified invention.

13. The application of claim 9, further comprising:
before preparing the patent application, and
if the proposed invention has been modified before or during invention market analysis, thereby providing a modified invention, and
if the modified invention needs analysis of known prior art so as to ascertain a potentially patentable scope of the modified invention,
analyzing known prior art, so as to ascertain a potentially patentable scope of the modified invention in light of the known prior art.

14. The application of claim 9, wherein at least one of:
the invention market analysis; and
preparing the patent application,
is performed by at least one of:
an inventor of the proposed invention;
a market professional; and
a patent professional.

15. The application of claim 9, wherein preparing the patent application includes at least one of:
creating a patent strategy in light of the invention market analysis of the proposed invention, so as to provide a market-targeted patent strategy;
describing the proposed invention in light of the invention market analysis of the proposed invention, so as to provide a market-targeted invention description; and
drafting patent claims in light of the invention market analysis of the proposed invention, so as to provide market-targeted patent claims.

16. The application of claim 9, wherein preparing the patent application includes using the invention market analysis of the proposed invention to perform at least one of:
reshaping the scope of the proposed invention;
narrowing the scope of the proposed invention;
broadening the scope of the proposed invention;
shifting the scope of the proposed invention;
redirecting the scope of the proposed invention;
displacing the scope of the proposed invention;
subdividing the proposed invention;
bifurcating the proposed invention; and
trifurcating the proposed invention.

17. A method for preparing a market-targeted patent application of enhanced commercial effectiveness and value, the method comprising:
obtaining a set of standard claims based on a proposed invention, the set of standard claims being drafted so as to define a potentially patentable scope of the proposed invention in light of the invention disclosure;
obtaining an invention market analysis of the proposed invention, the invention market analysis being performed using the set of standard claims based on the proposed invention;
drafting patent claims in light of the invention market analysis of the proposed invention, so as to provide market-targeted patent claims; and
preparing a patent application using the market-targeted patent claims.

18. The method of claim 17, wherein before the invention market analysis is performed, the proposed invention is clarified by:
analyzing known prior art so as to ascertain a potentially patentable scope of the proposed invention in light of the known prior art.

19. The method of claim 17, wherein results of the invention market analysis of the proposed invention are provided in a market report, the market report including at least one of:
an objective professional study; and
an informed subjective professional opinion.

20. The method of claim 17, further comprising:
before preparing the patent application so as to provide a market-targeted patent application, and
if the proposed invention has been modified before or during invention market analysis, thereby providing a modified invention, and
if the modified invention needs additional disclosure to support claims to the modified invention,
obtaining additional disclosure needed to support the claims to the modified invention.

21. The method of claim 17, further comprising:
before preparing the patent application, and
if the proposed invention has been modified before or during invention market analysis, thereby providing a modified invention, and
if the modified invention needs analysis of known prior art so as to ascertain a potentially patentable scope of the modified invention,
analyzing known prior art so as to ascertain a potentially patentable scope of the modified invention in light of the known prior art.

22. The method of claim 17, wherein at least one of:
the invention market analysis;
drafting patent claims in light of the invention market analysis of the proposed invention, so as to provide market-targeted patent claims; and
preparing the patent application,
is performed by at least one of:
an inventor of the proposed invention;
a market professional; and
a patent professional.

23. The method of claim 17, wherein preparing the patent application includes at least one of:
creating a patent strategy in light of the invention market analysis of the proposed invention, so as to provide a market-targeted patent strategy;
describing the proposed invention in light of the invention market analysis of the proposed invention, so as to provide a market-targeted invention description; and
including claims from the set of standard claims, along with claims from the market-targeted claims, within the market-targeted patent application.

24. The method of claim 17, wherein preparing the patent application includes using the invention market analysis of the proposed invention to perform at least one of:
reshaping the scope of the proposed invention;
narrowing the scope of the proposed invention;
broadening the scope of the proposed invention;
shifting the scope of the proposed invention;
redirecting the scope of the proposed invention;
displacing the scope of the proposed invention;
subdividing the proposed invention;
bifurcating the proposed invention; and
trifurcating the proposed invention.

25. A market-targeted patent application of enhanced commercial effectiveness and value, the application produced by the method comprising:
obtaining a set of standard claims based on a proposed invention, the set of standard claims being drafted so as to claim a potentially patentable scope of the proposed invention in light of the invention disclosure;
obtaining an invention market analysis of the proposed invention, the invention market analysis being performed using the set of standard claims based on the proposed invention; drafting patent claims in light of the invention market analysis of the proposed invention, so as to provide market-targeted patent claims; and
preparing a patent application using the market-targeted patent claims.
